(19) United States
(12) Patent Application Publication
(10) Pub. No.: US 2026/0037785 A1
(43) Pub. Date: Feb. 5, 2026

(54) ACCELERATING DIFFUSION MODELS WITH TEMPORAL SPARSITY

(71) Applicant: NVIDIA Corporation, Santa Clara, CA (US)

(72) Inventors: Zichen Fan, Santa Clara, CA (US); Steve Dai, Union City, CA (US); Rangharajan Venkatesan, Santa Clara, CA (US)

(21) Appl. No.: 19/091,691

(22) Filed: Mar. 26, 2025

Related U.S. Application Data
(60) Provisional application No. 63/678,979, filed on Aug. 2, 2024.

(51) Int. Cl. G06N 3/0495; G06N 3/049; G06N 3/08

(52) U.S. Cl. CPC G06N 3/0495; G06N 3/049; G06N 3/08

(57) ABSTRACT

Quantization and sparsity serve as the two pivotal techniques driving dramatic improvements in deep neural network (DNN) performance. However, for diffusion models quantization and sparsity fail to work out-of-the-box due to the unique characteristics of these models. The present disclosure provides for optimization of the execution of a diffusion model based on a time-dependent activation sparsity pattern of the diffusion model, which can provide acceleration of the diffusion model while achieving state-of-the-art generation quality at significantly reduced hardware costs.

### CLAIM OF PRIORITY

This application claims the benefit of U.S. Provisional Application No. 63/678,979 titled “Accelerating Generative Neural Networks using Temporal Per-Channel Sparsity,” filed Aug. 2, 2024, the entire contents of which is incorporated herein by reference.

### TECHNICAL FIELD

The present disclosure relates to methods and hardware to accelerate diffusion models.

### BACKGROUND

Diffusion models generate realistic contents by sequentially denoising data from random noise. They have emerged as the cornerstone of generative artificial intelligence (GenAI) for tasks such as image generation, video generation, and even weather prediction. However, generating high-quality contents is notably slow because it requires repeatedly evaluating a large and complex neural network model over many timesteps. Its complexity increases with higher resolution images and more advanced models, leading to large computation and memory overheads. Therefore, it is crucial to accelerate diffusion models to enable efficient deployment of real-world applications.

Quantization and sparsity serve as the two pivotal techniques driving dramatic improvements in deep neural network (DNN) performance over the last decade. Quantization enables reducing the precision of the weights and activations of a DNN, typically from 32-bit floating-point to low bit-width formats like 4-bit integers. Sparsity refers to the practice of pruning less important weights and activations, such as zeroing out the two smallest values for every four adjacent values in a tensor. In isolation or combination, quantization and sparsity can lead to substantial improvements in compute and memory efficiency of DNN execution with smaller model sizes, faster computations, and lower power consumption.

While quantization and sparsity remain the first-order considerations when accelerating diffusion models, these techniques fail to work out-of-the-box due to the unique characteristics of these models. First, quantization error accumulates over timesteps. Even small error in a single evaluation (timestep) of the model becomes compounded over the many model evaluations required to generate a single sample (e.g. one image). Second, activation distributions in diffusion models vary across layers and timesteps. This makes it difficult to apply a uniform quantization scheme over the entire generation process. Third, the data values within diffusion models tend to be extremely dense. The observed level of density precludes the effective use of sparse DNN accelerators for executing these models more efficiently.

There is a need for addressing these issues and/or other issues associated with the prior art. For example, there is a need to optimize execution of a diffusion model based on a time-dependent activation sparsity pattern, which can provide acceleration of the diffusion model while achieving state-of-the-art generation quality at significantly reduced hardware costs.

### SUMMARY

A method, computer readable medium, and system are disclosed for optimizing execution of a diffusion model. A time-dependent activation sparsity pattern for a diffusion model is determined. Execution of the diffusion model on an input dataset is optimized based on the time-dependent activation sparsity pattern.

### BRIEF DESCRIPTION OF THE DRAWINGS

FIG. 1 illustrates a flowchart of a method for optimizing execution of a diffusion model, in accordance with an embodiment.

FIG. 2 illustrates an exemplary per-channel time-dependent sparsity pattern for a diffusion model, in accordance with an embodiment.

FIG. 3A illustrates a block diagram of a system for optimizing execution of a diffusion model, in accordance with an embodiment.

FIG. 3B illustrates a block diagram of the architecture of the system of FIG. 3A, in accordance with an embodiment.

FIG. 4 illustrates a method for optimized execution of a diffusion model based on a per-channel time-dependent sparsity pattern of the diffusion model, in accordance with an embodiment.

FIG. 5A illustrates inference and/or training logic, according to at least one embodiment.

FIG. 5B illustrates inference and/or training logic, according to at least one embodiment.

FIG. 6 illustrates training and deployment of a neural network, according to at least one embodiment.

FIG. 7 illustrates an example data center system, according to at least one embodiment.

### DETAILED DESCRIPTION

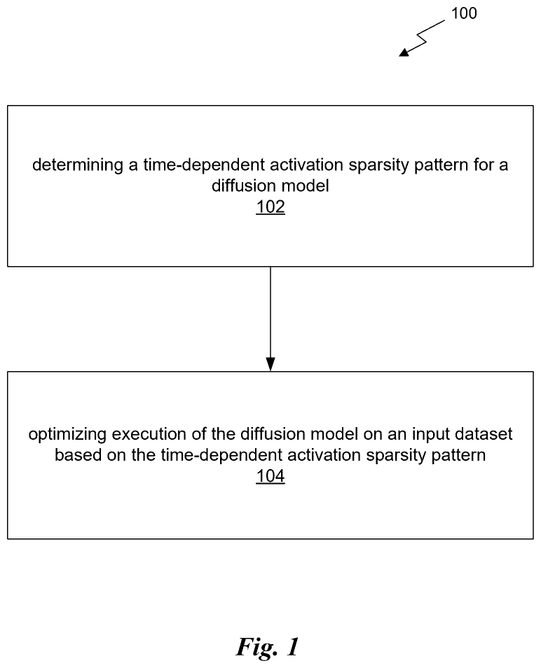

FIG. 1 illustrates a flowchart of a method 100 for optimizing execution of a diffusion model, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

With respect to the present description, the diffusion model refers to a generative machine learning model that is configured to generate data from noise by sequentially denoising the data over a diffusion process. The data may be an image, a video frame, or any other type of data capable of being generated from noise. The diffusion model denoises the data through a plurality of channels and over a plurality of timesteps. However, these channels, or even subparts thereof, will generally exhibit varying degrees of activation sparsity over the plurality of timesteps, or in other words the level of activation sparsity exhibited by the diffusion model during the diffusion (denoising) process will vary per-channel (or per-channel subpart) and per-timestep. This varying activation sparsity is referred to herein as a time-dependent activation sparsity pattern. In embodiments, the sparsity in activation values may have been introduced to the model or increased in the model via pruning, using ReLU (Rectified Linear Unit) activation function, and/or other sparsification techniques. The present method 100, as described below, leverages the time-dependent activation sparsity pattern for the diffusion model to optimize execution of the diffusion model on an input dataset for generating data.

Returning to the method 100, in operation 102, the time-dependent activation sparsity pattern for the diffusion model is determined. The pattern may be determined with respect to a predefined activation level. In an embodiment, the time-dependent activation sparsity pattern may include a pixel-level activation sparsity pattern, or in other words may define the activation sparsity per pixel and per timestep of the diffusion process. In another embodiment, the time-dependent activation sparsity pattern includes a block-level activation sparsity pattern, or in other words may define the activation sparsity per pixel block and per timestep of the diffusion process. In yet another embodiment, the time-dependent activation sparsity pattern includes a channel-level activation sparsity pattern, or in other words may define the activation sparsity per channel and per timestep of the diffusion process.

In an embodiment, the time-dependent activation sparsity pattern may be defined in terms of one or more predefined criteria. The predefined criteria may include sparsity type, activation level, select timesteps, etc. For example, in an embodiment, the time-dependent activation sparsity pattern may be defined by a sparsity type for activations of the diffusion model at a defined level and over a plurality of different timesteps of a diffusion process of the diffusion model. As mentioned above the defined level may be one of a pixel-level, a block-level or a channel-level. Further, in an embodiment, the time-dependent activation sparsity pattern may be defined over each timestep of the diffusion process of the diffusion model or over a select subset of timesteps of the diffusion process of the diffusion model. Still yet, in an embodiment, the sparsity type may be selected from among a plurality of predefined sparsity types which may include a sparse type and a dense type and/or which may be differentiated by at least one sparsity threshold (e.g. with each predefined sparsity type being defined by differing sparsity thresholds between 0% dense to 100% dense).

In an embodiment, the time-dependent activation sparsity pattern may be statically determined. With respect to this embodiment, the time-dependent activation sparsity pattern may be statically determined before the execution of the diffusion model on the input dataset, for example, by executing the diffusion model on at least one representative set of data, and obtaining the time-dependent activation sparsity pattern for the diffusion model over the execution the diffusion model on the at least one representative set of data.

In another embodiment, the time-dependent activation sparsity pattern may be dynamically determined. With respect to this embodiment, the time-dependent activation sparsity pattern is dynamically determined during the execution of the diffusion model on the input dataset, for example by determining a current activation sparsity pattern at one or more preconfigured timesteps of a diffusion process of the diffusion model. In an embodiment, an activation sparsity pattern determined at a preconfigured timestep may be used to optimize the execution of the diffusion model (as described below) at one or more subsequent timesteps until a next activation sparsity pattern at a later preconfigured timestep is determined.

In yet another embodiment, the time-dependent activation sparsity pattern may be in part determined statically before the execution of the diffusion model on the input dataset and may be in part determined dynamically during the execution of the diffusion model on the input dataset. For example, one part of the sparsity pattern, such as with respect to one part of the activations and/or one part of the timesteps, may be determined statically before the execution of the diffusion model on the input dataset, whereas another part of the sparsity pattern, such as with respect to another part of the activations and/or another part of the timesteps, may be determined dynamically during the execution of the diffusion model on the input dataset.

In operation 104, execution of the diffusion model on the input dataset is optimized based on the time-dependent activation sparsity pattern. The input dataset refers to any data input to the diffusion model for processing to generate data therefrom (e.g. to generate an image, video, etc.).

With respect to the present description, optimizing the execution of the diffusion model refers to accelerating the execution of the diffusion model, which can result in the diffusion model executing in less time and/or using fewer resources. The execution of the diffusion model may be optimized in any desired manner that is based on the time-dependent activation sparsity pattern.

In an embodiment, execution of the diffusion model may be optimized by processing sparse activations using at least one first processor core configured to perform sparse computations and processing dense activations using at least one second processor core configured to perform dense computations. The sparse activations and dense activations may be determined from the time-dependent activation sparsity pattern. For example, sparse activations may include activations with more than a threshold level of sparsity, as indicated in the time-dependent activation sparsity pattern, whereas dense activations may include activations with less than the threshold level of sparsity, as indicated in the time-dependent activation sparsity pattern.

Accordingly, in an embodiment, at each timestep indicated in the time-dependent activation sparsity pattern, the sparse activations at that timestep may be processed using the at least one first processor core configured to perform sparse computations and the dense activations at that timestep may be processed using the at least one second processor core configured to perform dense computations. In an embodiment, the sparse computations may include less computations than the dense computations, such that the sparse computations may be performed in less time than the dense computations and/or such that the sparse computations may require fewer resources to execute than the dense computations. For example, the sparse computations may be formed by selectively skipping one or more of the dense computations. In other words, where a dense computation (used to process a dense activation) involves a particular set of computations then a sparse computation (used to process a sparse activation) involves a subset of computations in the particular set of computations. In this way, fewer computations may be used to process a sparse activation than to process a dense activation.

In an embodiment, one or more processors may be configured to process an activation in accordance with its level of sparsity as indicated in the time-dependent activation sparsity pattern. For example, the one or more processors may be configured to process sparse activations using the sparse computations and may be configured to process dense activations using the dense computations. In an embodiment, different processor cores may be configured to perform each of the sparse computations and the dense computations.

In an embodiment, the time-dependent activation sparsity pattern may be made accessible to a hardware controller for optimizing execution of the diffusion model based on the time-dependent activation sparsity pattern. For example, in an embodiment, the hardware controller may configure at least one first processor core to perform sparse computations for sparse activations indicated by the time-dependent activation sparsity pattern and may further configure at least one second processor core to perform dense computations for dense activations indicated by the time-dependent activation sparsity pattern. In another embodiment, the hardware controller may assign sparse activations to the at least one first processor core configured to perform sparse computations and may assign dense activations to the at least one second processor core configured to perform dense computations.

To this end, since during a diffusion process the diffusion model is expected to exhibit varying activation sparsity over time per-channel or per-channel subpart, the method 100 may be performed to leverage this activation sparsity at various timesteps of the diffusion process in order to optimize execution of the diffusion model. As described above, this optimization may accelerate the execution of the diffusion model such that the diffusion model executes in less time and/or using fewer resources.

Further embodiments will now be provided in the description of the subsequent figures. It should be noted that the embodiments disclosed herein with reference to the method 100 of FIG. 1 may apply to and/or be used in combination with any of the embodiments of the remaining figures below.

During execution, diffusion models will generally exhibit varying degrees of activation sparsity over time. It has been observed that the activation sparsity over time forms a pattern on a per activation level basis. For example, instead of random sparsity, a temporal per-channel sparsity pattern may be exhibited in diffusion models, including particularly in ReLU-based diffusion models. As described herein, this sparsity pattern can be effectively exploited for acceleration of the diffusion model.

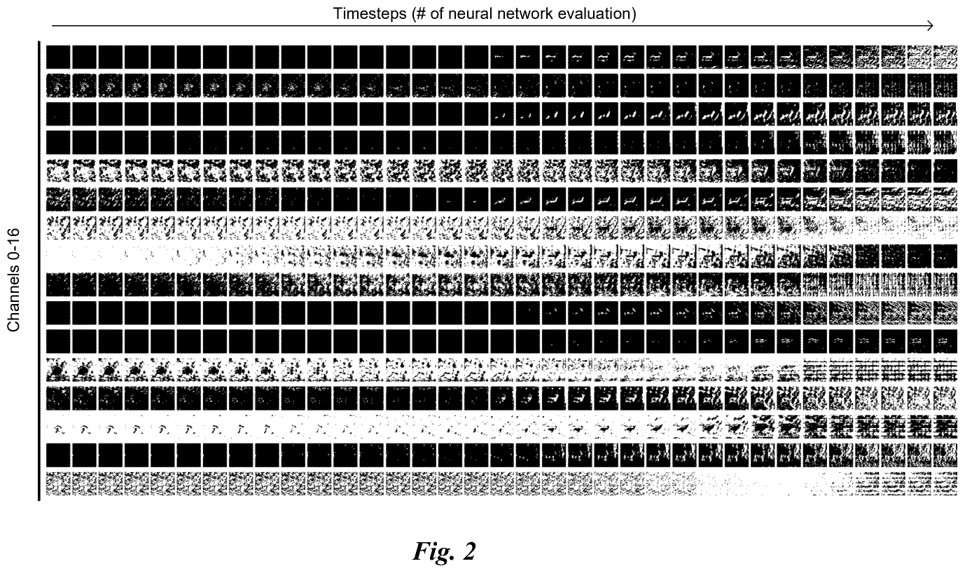

FIG. 2 illustrates an exemplary per-channel time-dependent sparsity pattern for a diffusion model, in accordance with an embodiment. In this example, the sparsity pattern is illustrated in particular for the activations of a single layer of the diffusion model. The values are binarized: zero values are represented in black, and non-zero values in white. Each row corresponds to a channel (32×32 block) of the activation tensor, while each column represents a timestep in the diffusion process.

From the example pattern shown, it is evident that different channels exhibit distinct sparsity characteristics; some channels are highly sparse (with predominantly black pixels) while others are dense (with mostly white pixels). Furthermore, the sparsity of each individual channel varies across timesteps; sparse channels can become dense and vice versa. This temporal per-channel sparsity presents an opportunity for acceleration: sparse channels can be grouped and processed using a sparse engine comprised of one or more first processor cores, while dense channels can be handled by a dense engine comprised of one or more second processor cores.

The embodiments provided below describe the hardware that can leverage the time-dependent sparsity patterns of diffusion models.

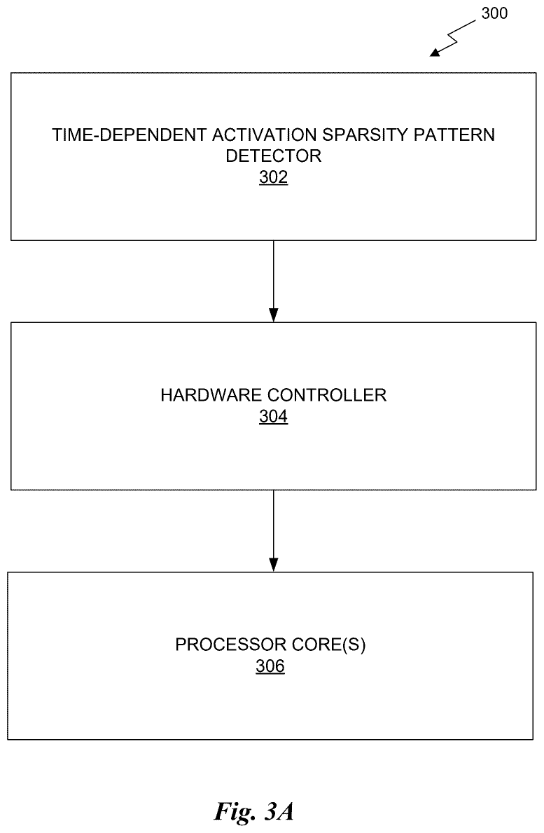

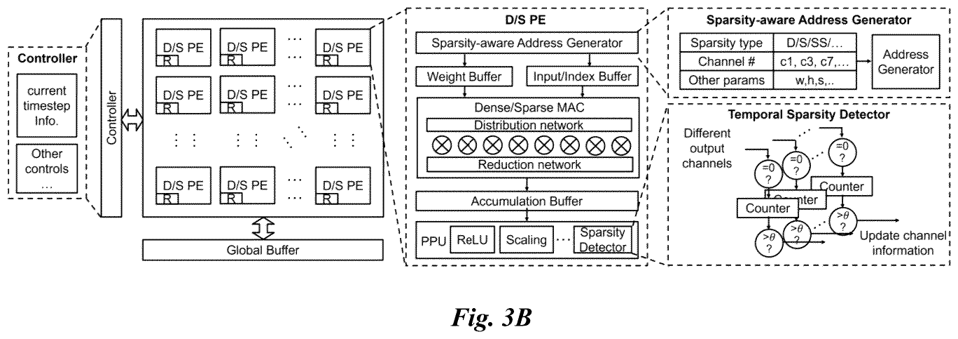

FIG. 3A illustrates a block diagram of a system 300 for optimizing execution of a diffusion model, in accordance with an embodiment. The system 300 may be implemented in the context of the embodiments described above. For example, the system 300 may be implemented to carry out the method 100 of FIG. 1. Accordingly, the definitions and embodiments described above may equally apply to the present description.

As shown, the system 300 includes a time-dependent activation sparsity pattern detector 302. The time-dependent activation sparsity pattern detector 302 is configured to determine a time-dependent activation sparsity pattern for the diffusion model. The time-dependent activation sparsity pattern detector 302 may be implemented in software, hardware, or a combination thereof.

The time-dependent activation sparsity pattern determined by the time-dependent activation sparsity pattern detector 302 is made available to a hardware controller 304. The hardware controller 304 is configured to optimize execution of the diffusion model on an input dataset based on the time-dependent activation sparsity pattern. The hardware controller 304 refers to a hardware component that is configured to control one or more processor cores 306 to execute the diffusion model on the input dataset in a manner that optimizes execution of the diffusion model per the time-dependent activation sparsity pattern.

In an embodiment, at each timestep covered by the time-dependent activation sparsity pattern, the hardware controller 304 may configure at least one first processor core 306 to perform sparse computations for sparse activations indicated by the time-dependent activation sparsity pattern at that timestep. Similarly, the hardware controller 304 may further configure at least one second processor core 306 to perform dense computations for dense activations indicated by the time-dependent activation sparsity pattern at that timestep.

FIG. 3B illustrates a block diagram of the architecture of the system of FIG. 3A, in accordance with an embodiment. The architecture relies on a particular computation scheme to accelerate the temporal per-channel sparsity pattern observed in diffusion model activations. It should be noted that while the pattern is disclosed herein as being defined at a per-channel level, other embodiments may likewise define the pattern at a per-subchannel level (e.g. per pixel, per pixel block, etc.).

In general, the architecture is configured to categorize the activation tensor into sparse and dense channels. By grouping channels (including both weights and activations) based on the activation sparsity type, the computation can be optimized. It should be noted that in the present embodiments the weights may always be dense. Dense channel groups are processed using the dense processing unit, while sparse channel groups are computed using the sparse processing unit. After that, the partial sums are added together to get the final result.

Overall Architecture

As illustrated in FIG. 3B, the overall architecture includes three main components: a controller (e.g. item 204 of FIG. 2), a dense/sparse processing element (D/S PE) array (e.g. items 206 of FIG. 2), and an interconnection network between the global buffer and the PEs. The controller manages timestep information and orchestrates various PEs through control logic. The architecture features two types of PEs: Dense Processing Elements (DPEs) for dense channel computation and Sparse Processing Elements (SPEs) for sparse channel computation. These PEs are interconnected via configurable routers (R), enabling efficient processing of both dense and sparse data.

The D/S PE consists of several components: a sparsity-aware address generator, weight/input/accumulation buffers, dense/sparse datapaths, and a post-processing unit (PPU) with a sparsity detector (e.g. item 202 of FIG. 2). Each PE can be configured to either the dense or sparse datapath, depending on the computation type. Based on the sparsity pattern, either the dense or sparse vector MAC datapath is employed to compute partial sums. In one exemplary embodiment, a MAERI-like architecture may be used for the dense MAC datapath and a SIGMA-like architecture may be used for the sparse MAC datapath, as both architectures are well-suited for handling irregular matrix sizes. SIGMA's flexible distribution and reduction networks also enable efficient processing of irregular matrix sparsity.

After processing all input channels, the data from the accumulation buffer is passed through the PPU. The sparsity-aware address generator maintains channel information, including sparsity type (dense, sparse, etc.) and the corresponding channel index. Utilizing this information, the address generator produces the necessary weight and activation addresses to fetch data from the global buffer. A temporal sparsity detector in the PPU identifies per-channel sparsity in the output. The number of zeros is compared against a predefined threshold to update the sparse channel index information for the next layer in the sparsity-aware address generator.

### Channel-Last Memory Mapping

To accommodate the non-continuous input channel order required by the sparsity-aware address generator when fetching data from the global buffer, a channel-last data mapping strategy may be used. For activations, the address mapping follows the sequence of width (W), height (H), and input/output channel (C) being the last, enabling the PE to fetch the entire dense/sparse input/output channel. For sparse channels, only nonzero values and its binary indicator (0 for zero and 1 for non-zero) are stored in the memory, which aligns with the SIGMA sparse accelerator architecture. For weights, the mapping sequence is kernel width (S), kernel height (R), output channel (K), and then input channel (C). This channel-last ordering ensures that the corresponding weights are fetched to align with the activations, optimizing the computation process.

### Temporal Sparsity Detection

The temporal sparsity detector calculates the output per-channel sparsity and assigns each channel as either dense or sparse. The sparsity threshold distinguishing dense from sparse channels may be defined in order to balance the execution time between the dense PE and sparse PE.

Finally, a temporal sparsity update scheduling mechanism is used to address the dynamic per-channel sparsity observed across timesteps. Generally, more frequent sparsity updates (i.e., fewer timesteps in between updates) improves the accuracy of sparse/dense tensor categorization, resulting in higher system speed-up. Since the overhead of sparsity updates is negligible compared to the overall computation cost and can be hidden behind computation latency, in an embodiment the per-channel sparsity may be updated at every timestep during diffusion model execution to maximize categorization accuracy and system speed-up. Of course, in other embodiments the per-channel sparsity may be updated per group of timesteps, with each group comprised of a predefined number of sequential timesteps.

To this end, the architecture may provide a software/hardware co-designed optimization of the diffusion model. By using a heterogeneous dense/sparse accelerator architecture, speed-up of the execution of the diffusion model may be achieved while also providing state-of-the-art data generation quality. By leveraging temporally sparse computations, energy consumption may also be reduced compared to traditional dense accelerators.

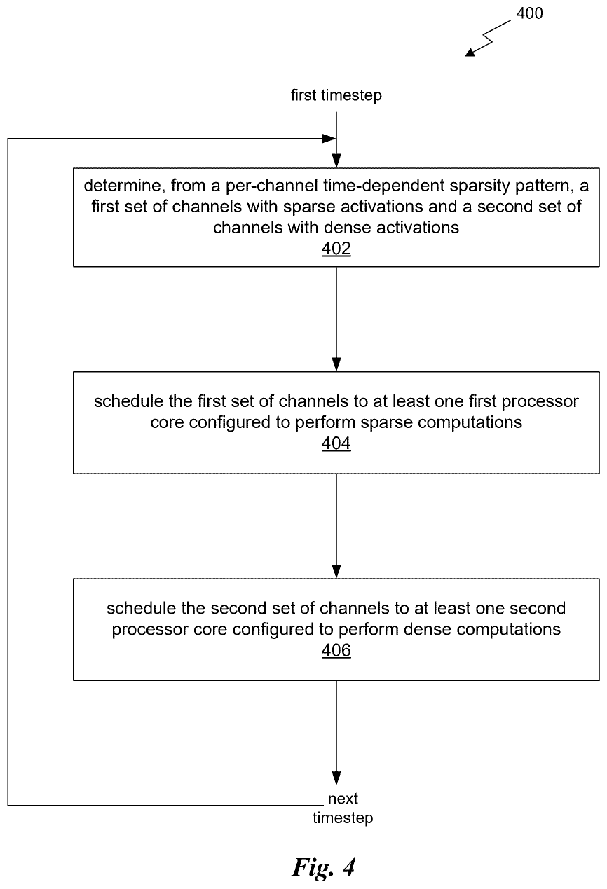

FIG. 4 illustrates a method 400 for optimized execution of a diffusion model based on a per-channel time-dependent sparsity pattern of the diffusion model, in accordance with an embodiment. The method 400 may be carried out in the context of FIGS. 3A-B. For example, the method 400 may be carried out by the hardware controller 304 of FIG. 3A.

As shown, the method 400 may be carried out for each timestep of the execution of the diffusion model. Thus, in an embodiment, the method 400 may initiate for a first timestep of the execution of the diffusion model. It should be noted that while the present method 400 is described as being carried out for each timestep, in another implementation the method 400 may be carried out after every predetermined number (N) of time steps where N>1.

In operation 402, a first set of channels with sparse activations and a second set of channels with dense activations are determined from a per-channel time-dependent sparsity pattern. The first set of channels with sparse activations include those channels with activations having more than a threshold level of sparsity at the current timestep of the execution of the diffusion model. The second set of channels with dense activations include those channels with activations having less than the threshold level of sparsity at the current timestep of the execution of the diffusion model. In an embodiment, the threshold may be determined based on hardware characteristics, or in other words characteristics of the hardware that will execute the diffusion model.

As mentioned, the first set of channels and the second set of channels are determined from the per-channel time-dependent sparsity pattern. In the present embodiment, this pattern is precomputed for the diffusion model. In particular, the per-channel time-dependent sparsity pattern indicates, for each timestep of diffusion model execution, which channels have sparse activations and which channels have dense activations.

In operation 404, the first set of channels are scheduled to at least one first processor core configured to perform sparse computations. In operation 406, the second set of channels are scheduled to at least one second processor core configured to perform dense computations. It should be noted that operations 404 and 406 may be performed in any sequence or in parallel. The first and second processor cores are then caused to process the channel activations scheduled thereto using their respective sparse/dense computations. The method 400 repeats for a next timestep of the execution of the diffusion model, as shown.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

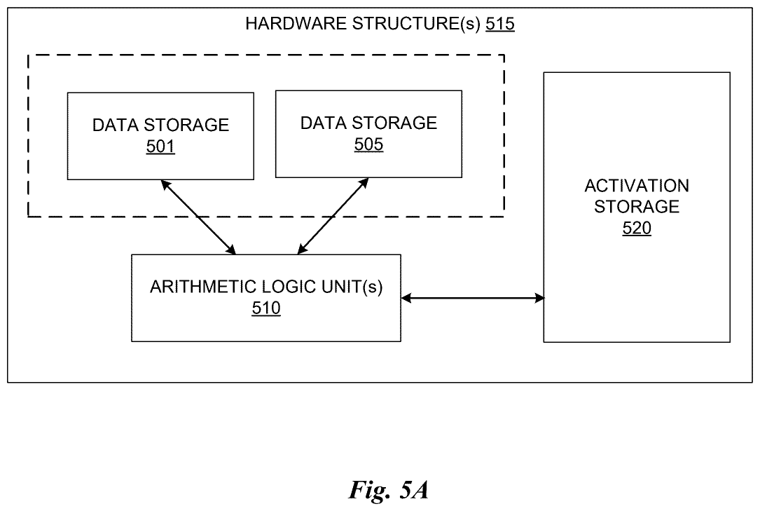

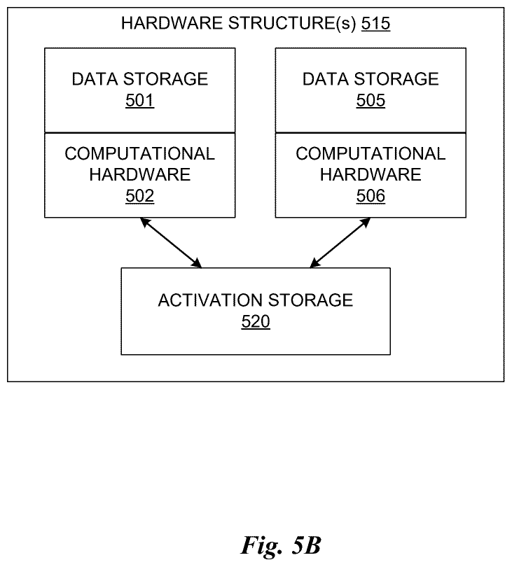

As noted above, a deep learning or neural learning system needs to be trained to generate inferences from input data. Details regarding inference and/or training logic 515 for a deep learning or neural learning system are provided below in conjunction with FIGS. 5A and/or 5B.

In at least one embodiment, inference and/or training logic 515 may include, without limitation, a data storage 501 to store forward and/or output weight and/or input/output data corresponding to neurons or layers of a neural network trained and/or used for inferencing in aspects of one or more embodiments. In at least one embodiment data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 501 may be included with other on-chip or off-chip data storage, including a processor's L1, L2, or L3 cache or system memory.

In at least one embodiment, any portion of data storage 501 may be internal or external to one or more processors or other hardware logic devices or circuits. In at least one embodiment, data storage 501 may be cache memory, dynamic randomly addressable memory (“DRAM”), static randomly addressable memory (“SRAM”), non-volatile memory (e.g., Flash memory), or other storage. In at least one embodiment, choice of whether data storage 501 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a data storage 505 to store backward and/or output weight and/or input/output data corresponding to neurons or layers of a neural network trained and/or used for inferencing in aspects of one or more embodiments. In at least one embodiment, data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 505 may be included with other on-chip or off-chip data storage, including a processor's L1, L2, or L3 cache or system memory. In at least one embodiment, any portion of data storage 505 may be internal or external to on one or more processors or other hardware logic devices or circuits. In at least one embodiment, data storage 505 may be cache memory, DRAM, SRAM, non-volatile memory (e.g., Flash memory), or other storage. In at least one embodiment, choice of whether data storage 505 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 501 and data storage 505 may be separate storage structures. In at least one embodiment, data storage 501 and data storage 505 may be same storage structure. In at least one embodiment, data storage 501 and data storage 505 may be partially same storage structure and partially separate storage structures. In at least one embodiment, any portion of data storage 501 and data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510 to perform logical and/or mathematical operations based, at least in part on, or indicated by, training and/or inference code, result of which may result in activations (e.g., output values from layers or neurons within a neural network) stored in an activation storage 520 that are functions of input/output and/or weight parameter data stored in data storage 501 and/or data storage 505. In at least one embodiment, activations stored in activation storage 520 are generated according to linear algebraic and or matrix-based mathematics performed by ALU(s) 510 in response to performing instructions or other code, wherein weight values stored in data storage 505 and/or data 501 are used as operands along with other values, such as bias values, gradient information, momentum values, or other parameters or hyperparameters, any or all of which may be stored in data storage 505 or data storage 501 or another storage on or off-chip. In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALUs 510 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 501, data storage 505, and activation storage 520 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., Flash memory), or other storage. In at least one embodiment, activation storage 520 may be completely or partially within or external to one or more processors or other logical circuits. In at least one embodiment, choice of whether activation storage 520 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 515 illustrated in FIG. 5A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, data storage 501 and data storage 505, which may be used to store weight values and/or other information, including bias values, gradient information, momentum values, and/or other parameter or hyperparameter information. In at least one embodiment illustrated in FIG. 5B, each of data storage 501 and data storage 505 is associated with a dedicated computational resource, such as computational hardware 502 and computational hardware 506, respectively. In at least one embodiment, each of computational hardware 506 comprises one or more ALUs that perform mathematical functions, such as linear algebraic functions, only on information stored in data storage 501 and data storage 505, respectively, result of which is stored in activation storage 520.

In at least one embodiment, each of data storage 501 and 505 and corresponding computational hardware 502 and 506, respectively, correspond to different layers of a neural network, such that resulting activation from one “storage/computational pair 501/502” of data storage 501 and computational hardware 502 is provided as an input to next “storage/computational pair 505/506” of data storage 505 and computational hardware 506, in order to mirror conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage computation pairs 501/502 and 505/506 may be included in inference and/or training logic 515.

### Neural Network Training and Deployment

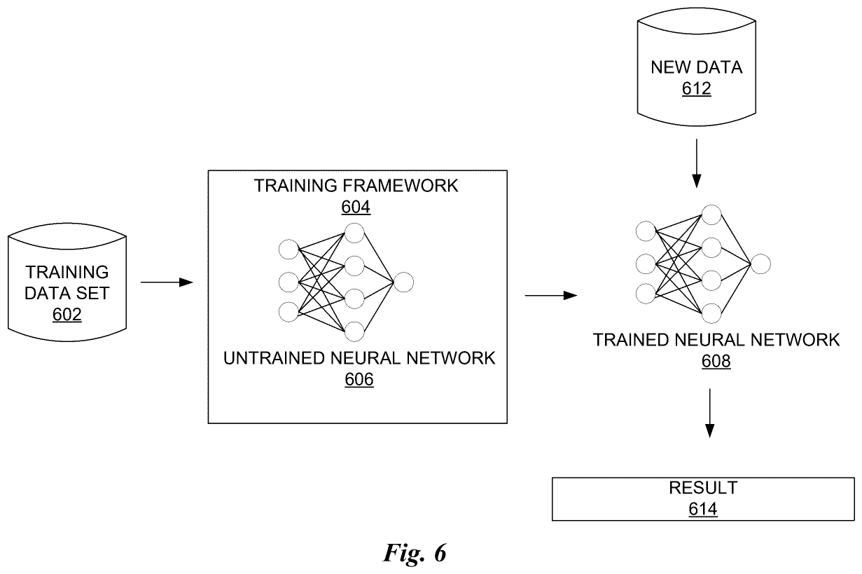

FIG. 6 illustrates another embodiment for training and deployment of a deep neural network. In at least one embodiment, untrained neural network 606 is trained using a training dataset 602. In at least one embodiment, training framework 604 is a PyTorch framework, whereas in other embodiments, training framework 604 is a Tensorflow, Boost, Caffe, Microsoft Cognitive Toolkit/CNTK, MXNet, Chainer, Keras, Deeplearning4j, or other training framework. In at least one embodiment training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having known output and the output of the neural network is manually graded. In at least one embodiment, untrained neural network 606 is trained in a supervised manner processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on known input data, such as new data 612. In at least one embodiment, training framework 604 trains untrained neural network 606 repeatedly while adjust weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map, which is a type of trained neural network 608 capable of performing operations useful in reducing dimensionality of new data 612. In at least one embodiment, unsupervised training can also be used to perform anomaly detection, which allows identification of data points in a new dataset 612 that deviate from normal patterns of new dataset 612.

In at least one embodiment, semi-supervised learning may be used, which is a technique in which in training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new data 612 without forgetting knowledge instilled within network during initial training.

### Data Center

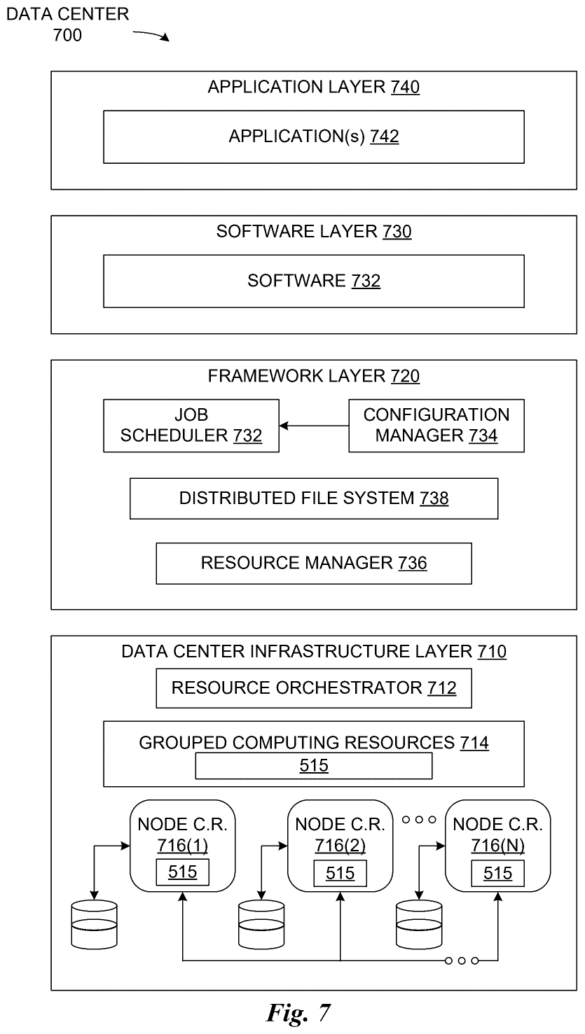

FIG. 7 illustrates an example data center 700, in which at least one embodiment may be used. In at least one embodiment, data center 700 includes a data center infrastructure layer 710, a framework layer 720, a software layer 730 and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 722 may configure or otherwise control one or more node C.R.s 716(1)-716(N) and/or grouped computing resources 714. In at least one embodiment, resource orchestrator 722 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 732, a configuration manager 734, a resource manager 736 and a distributed file system 738. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache SparkTM (hereinafter “Spark”) that may utilize distributed file system 738 for large-scale data processing (e.g., “big data”). In at least one embodiment, job scheduler 732 may include a Spark driver to facilitate scheduling of workloads supported by various layers of data center 700. In at least one embodiment, configuration manager 734 may be capable of configuring different layers such as software layer 730 and framework layer 720 including Spark and distributed file system 738 for supporting large-scale data processing. In at least one embodiment, resource manager 736 may be capable of managing clustered or grouped computing resources mapped to or allocated for support of distributed file system 738 and job scheduler 732. In at least one embodiment, clustered or grouped computing resources may include grouped computing resource 714 at data center infrastructure layer 710. In at least one embodiment, resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

As described herein, a method, computer readable medium, and system are disclosed to provide optimization of a diffusion model. In accordance with FIGS. 1-4, embodiments may include a diffusion model usable for performing inferencing operations and for providing inferenced data. The diffusion model may be stored (partially or wholly) in one or both of data storage 501 and 505 in inference and/or training logic 515 as depicted in FIGS. 5A and 5B. Training and deployment of the diffusion model may be performed as depicted in FIG. 6 and described herein. Distribution of the diffusion model may be performed using one or more servers in a data center 700 as depicted in FIG. 7 and described herein.

What is claimed is:

1. A method, comprising:
at a device:
determining a time-dependent activation sparsity pattern for a diffusion model; and
optimizing execution of the diffusion model on an input dataset based on the time-dependent activation sparsity pattern.

2. The method of claim 1, wherein the time-dependent activation sparsity pattern includes a pixel-level activation sparsity pattern.

3. The method of claim 1, wherein the time-dependent activation sparsity pattern includes a block-level activation sparsity pattern.

4. The method of claim 1, wherein the time-dependent activation sparsity pattern includes a channel-level activation sparsity pattern.

5. The method of claim 1, wherein the time-dependent activation sparsity pattern is defined by a sparsity type for activations of the diffusion model at a defined level and over a plurality of different timesteps of a diffusion process of the diffusion model.

6. The method of claim 5, wherein the defined level is one of:
a pixel-level,
a block-level, or
a channel-level.

7. The method of claim 5, wherein the time-dependent activation sparsity pattern is defined over each timestep of the diffusion process of the diffusion model.

8. The method of claim 5, wherein the sparsity type is selected from among a plurality of predefined sparsity types.

9. The method of claim 8, wherein the plurality of predefined sparsity types include:
a sparse type, and
a dense type.

10. The method of claim 8, wherein the plurality of predefined sparsity types are differentiated by at least one sparsity threshold.

11. The method of claim 1, wherein the time-dependent activation sparsity pattern is statically determined.

12. The method of claim 11, wherein the time-dependent activation sparsity pattern is statically determined before the execution of the diffusion model on the input dataset by:
executing the diffusion model on at least one representative set of data, and
obtaining the time-dependent activation sparsity pattern for the diffusion model over the execution the diffusion model on the at least one representative set of data.

13. The method of claim 1, wherein the time-dependent activation sparsity pattern is dynamically determined.

14. The method of claim 13, wherein the time-dependent activation sparsity pattern is dynamically determined during the execution of the diffusion model on the input dataset by:
determining a current activation sparsity pattern at one or more preconfigured timesteps of a diffusion process of the diffusion model.

15. The method of claim 14, wherein an activation sparsity pattern determined at a preconfigured timestep is used to optimize the execution of the diffusion model at one or more subsequent timesteps until a next activation sparsity pattern at a later preconfigured timestep is determined.

16. The method of claim 1, wherein the time-dependent activation sparsity pattern is in part determined statically before the execution of the diffusion model on the input dataset and is in part determined dynamically during the execution of the diffusion model on the input dataset.

17. The method of claim 1, wherein optimizing execution of the diffusion model based on the time-dependent activation sparsity pattern includes:
processing sparse activations using at least one first processor core configured to perform sparse computations, and
processing dense activations using at least one second processor core configured to perform dense computations.

18. The method of claim 17, wherein the sparse computations include less computations than the dense computations.

19. The method of claim 17, wherein the sparse computations are formed by selectively skipping one or more of the dense computations.

20. The method of claim 1, wherein the time-dependent activation sparsity pattern is made accessible to a hardware controller for optimizing execution of the diffusion model based on the time-dependent activation sparsity pattern.

21. The method of claim 20, wherein the hardware controller configures at least one first processor core to perform sparse computations for sparse activations indicated by the time-dependent activation sparsity pattern and further configures at least one second processor core to perform dense computations for dense activations indicated by the time-dependent activation sparsity pattern.

22. The method of claim 21, wherein the hardware controller assigns sparse activations to the at least one first processor core configured to perform sparse computations and assigns dense activations to the at least one second processor core configured to perform dense computations.

23. A system, comprising:
a non-transitory memory storage comprising instructions;
one or more processors in communication with the memory, wherein the one or more processors execute the instructions to:
determine a time-dependent activation sparsity pattern for a diffusion model; and
a hardware controller to:
optimize execution of the diffusion model on an input dataset based on the time-dependent activation sparsity pattern.

24. The system of claim 23, wherein the hardware controller configures at least one first processor core to perform sparse computations for sparse activations indicated by the time-dependent activation sparsity pattern and further configures at least one second processor core to perform dense computations for dense activations indicated by the time-dependent activation sparsity pattern.

25. The system of claim 24, wherein the hardware controller assigns sparse activations to the at least one first processor core configured to perform sparse computations and assigns dense activations to the at least one second processor core configured to perform dense computations.

26. A non-transitory computer-readable media storing computer instructions which when executed by one or more processors of a device cause the device to:
determine a time-dependent activation sparsity pattern for a diffusion model; and
optimize execution of the diffusion model on an input dataset based on the time-dependent activation sparsity pattern.

27. The non-transitory computer-readable media of claim 26, wherein the time-dependent activation sparsity pattern is defined by a sparsity type for activations of the diffusion model at a defined level and over a plurality of different timesteps of a diffusion process of the diffusion model.

28. The non-transitory computer-readable media of claim 27, wherein the defined level is one of:
a pixel-level,
a block-level, or
a channel-level.

29. The non-transitory computer-readable media of claim 26, wherein optimizing execution of the diffusion model based on the time-dependent activation sparsity pattern includes:
processing sparse activations using at least one first processor core configured to perform sparse computations, and
processing dense activations using at least one second processor core configured to perform dense computations.
